(19) United States
(12) Patent Application Publication
(10) Pub. No.: US 2010/0284284 A1
(43) Pub. Date: Nov. 11, 2010

(54) VOICE OVER INTERNET PROTOCOL (VoIP) ACCESS TERMINAL

(75) Inventor: Deepak Khandelwal, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/463,036

(22) Filed: May 8, 2009

(51) Int. Cl. H04L 12/26; H04L 12/66

(52) U.S. Cl. 370/248; 370/352

(57) ABSTRACT

An access terminal includes a processing system configured to determine whether a voice over internet protocol (VoIP) communication channel is available. The processing system is also configured, upon entry into a VoIP-enabled communication environment, to provide without manual intervention a first request for one or more VoIP network connection resources to initiate communication between the access terminal and a packet data gateway over a VoIP communication channel. A method and a processing system are also provided for initiating a VoIP service.

### BACKGROUND

Advancements in wireless technology have led to the existence of multiple wireless communication platforms. These platforms may include cell phones that communicate through wireless connection to cellular communication towers, using wireless technology such as Code Division Multiple Access (CDMA) protocols. These platforms may also include Voice over Internet Protocol (VoIP) systems, where voice or data is transmitted and received using an Internet Protocol, such as the 802.11 standard or the 802.21 standard. Communications networks can include, for example, two types of networks: (i) circuit-switched networks, where information (either voice or data) is transmitted using a fixed route between a beginning point and an end point, and (ii) packet-switched networks, where the information (whether voice or data) is divided into packets, and the packets are transmitted between the beginning point and the end point without a fixed route there between.

In certain VoIP applications, for instance certain Binary Run-time Environment for Wireless (BREW) applications, a user is required to select a VoIP communication channel via a menu along with a request that the VoIP communication channel be activated. In such VoIP applications, manual intervention is required each time that the application is unable to acquire a VoIP communication channel. Even in situations where certain BREW-enabled access terminals are physically within a coverage area for a VoIP communication channel where the access terminals might be provided with VoIP capability using a Point-to-Point Protocol (PPP) link-up providing proper Quality of Service (QoS) for the access terminals, the access terminals will not request these resources automatically.

### SUMMARY

In one aspect of the disclosure, an access terminal comprises a processing system configured to determine whether a voice over internet protocol (VoIP) communication channel is available. The processing system is also configured, upon entry into a VoIP-enabled communication environment, to provide without manual intervention a first request for one or more VoIP network connection resources to initiate communication between the access terminal and a packet data gateway over a VoIP communication channel.

In a further aspect of the disclosure, a method is provided for initiating a voice over internet protocol (VoIP) service. The method comprises determining whether a VoIP communication channel is available. The method further comprises, upon entry into a VoIP-enabled communication environment, providing without manual intervention a first request for one or more VoIP network connection resources to initiate communication between an access terminal and a packet data gateway over a VoIP communication channel.

In yet a further aspect of the disclosure, a processing system comprises a determining module and a requesting module. The determining module is configured to determine whether a voice over internet protocol (VoIP) communication channel is available. The requesting module is configured, upon entry into a VoIP-enabled communication environment, to provide without manual intervention a first request for one or more VoIP network connection resources to initiate communication between an access terminal and a packet data gateway over a VoIP communication channel.

In yet a further aspect of the disclosure, a processing system comprises means for determining whether a VoIP communication channel is available. The processing system further comprises means for providing without manual intervention, upon entry into a VoIP-enabled communication environment, a first request for one or more VoIP network connection resources to initiate communication between an access terminal and a packet data gateway over a VoIP communication channel.

In yet a further aspect of the disclosure, a machine-readable medium is encoded with instructions for initiating or performing a voice over internet protocol (VoIP) service. The instructions comprise code for determining whether a VoIP communication channel is available. The instructions further comprise code for, upon entry into a VoIP-enabled communication environment, providing without manual intervention a first request for one or more VoIP network connection resources to initiate communication between an access terminal and a packet data gateway over a VoIP communication channel.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

FIG. 1 is a conceptual block diagram illustrating an access terminal's connection to a VoIP network according to one configuration of the subject technology.

FIG. 2 is a conceptual block diagram illustrating an example of an access terminal.

FIG. 3A is a conceptual block diagram illustrating an example of an access terminal's functional components according to one configuration of the subject technology.

FIG. 3B is a conceptual block diagram illustrating an example of a determining module's functional components according to one configuration of the subject technology.

FIG. 4 is a conceptual graph illustrating examples of waiting periods that may be used by an access terminal in accordance with an aspect of the subject technology.

FIG. 5 is a conceptual flowchart illustrating an example of an operation of an access terminal in accordance with an aspect of the subject technology.

FIG. 6 is a conceptual flowchart illustrating another example of an operation of an access terminal in accordance with an aspect of the subject technology.

FIG. 7 is a conceptual block diagram illustrating an example of a processing system in accordance with an aspect of the subject technology.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology.

According to one aspect of the disclosure, transmission of information (whether voice or data) using a voice over internet protocol (VoIP) service depends on establishing a Point-to-Point Protocol (PPP) link-up through a Radio Area Network (RAN) between an access terminal and a packet data gateway (PDG). Data may include, for example, video, images, and/or other types of information. As part of the PPP link-up, the PDG needs to meet the Quality of Service (QoS) requirements demanded by the access terminal. QoS requirements may be, for example, Real-time Transport Protocol (RTP) requirements that define how streaming audio, video, and/or images may be sent over the Internet. A RTP transmission may include a Real-time Transport Control Protocol (RTCP) that monitors the QoS requirements to ensure that they are being met in an on-going PPP link-up.

A VoIP connection may use any one of various standards, for example, the 3GPP2 standard (otherwise known as the “Evolution Data Optimized Revision A” standard, or simply, “DO Rev A”) or High Speed Packet Access (HSPA) standard. With any VoIP connection, due to poor coverage or temporary congestion in a network, it is possible that an access terminal's request for a PPP link or for particular QoS requirements cannot be honored. When an access terminal makes a VoIP client request for a PPP link-up, corresponding QoS requirements need to be configured/allotted in the VoIP network, for subsequent use, to meet actual QoS levels. Once the request for a PPP link-up is made and positive confirmation is received at the access terminal (to include confirmation that QoS requirements can be met and have been allocated in the VoIP network), then the access terminal can transmit information (whether voice or data) as part of a VoIP service.

However, when the access terminal requests a PPP link-up (thereby requiring particular QoS allocations to be reserved in the network), the access terminal might be in a coverage area that is non-QoS enabled (such as a DO Rev 0 coverage area), or there may be temporary load conditions in the VoIP network that prohibit the grant of a QoS request.

In one aspect of the subject technology, an access terminal implements “back-off, retry” behavior when a first attempt to automatically establish a VoIP communication channel proves unsuccessful. Under this implementation of the subject technology, after a failure to connect to a VoIP communication channel (whether at power-up or after entering a VoIP-enabled communication area), the access terminal automatically re-initiates a PPP link-up request after a set time period has elapsed in an attempt to secure a VoIP communication channel for transmission of information (whether voice or data) from the access terminal to/from the VoIP network.

In certain configurations of the subject technology, an access terminal is configured to automatically connect to a newly available VoIP network. An access terminal may automatically request VoIP network resources without manual intervention by a user. Thus, acquisition of VoIP services for the access terminal can be made without manual intervention. An access terminal may continue to provide an established connection to another network while attempting to acquire the VoIP services. For example, while an access terminal is in communication with another access terminal via a non-VoIP network, the access terminal can request for VoIP network resources and acquire VoIP services without manual intervention.

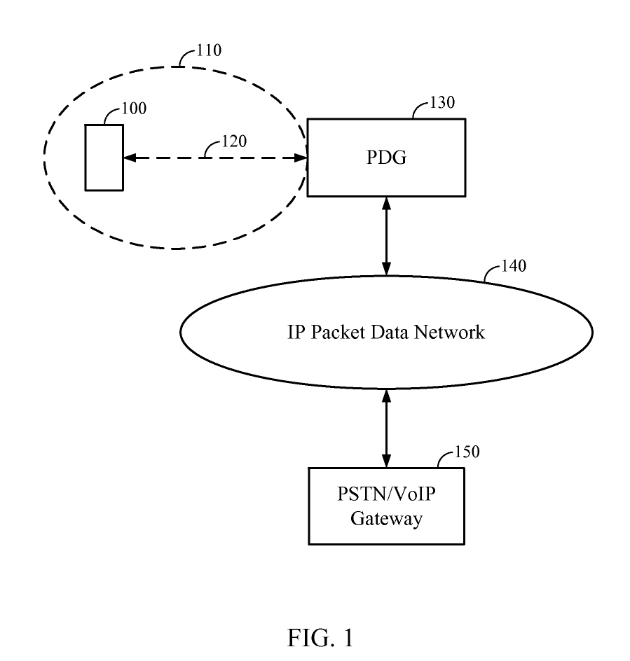

FIG. 1 is a conceptual block diagram illustrating an access terminal's connection to a VoIP network in an exemplary configuration of the subject technology. FIG. 1 shows an access terminal 100, a Radio Area Network (RAN) 110, a VoIP communication channel 120, a packet data gateway (PDG) 130, an Internet Protocol Packet Data Network 140, and a Public Switched Telephone Network / VoIP Gateway 150. The IP Packet Data Network 140 is a packet-switched network, and PSTN 150 is a circuit-switched network.

In one aspect of the disclosure, a RAN 110 is an example of a VoIP-enabled communication environment. In one aspect, a VoIP-enabled communication environment may be sometimes referred to as a VoIP-available communication environment, a VoIP-enabled communication area, a VoIP communication environment, a VoIP coverage area, or a VoIP network.

In one aspect of the disclosure, an access terminal 100 may be any communication device or a user-interface device, for example, without limitation: a cell phone, a smart phone, a Personal Digital Assistant (PDA), a laptop computer, a desktop computer, a mobile reader, an audio player, a game console, a camera, a camcorder, an audio device, a video device, a multimedia device, a component(s) of any of the foregoing (such as a printed circuit board(s), an integrated circuit(s), and/or a circuit component(s)), or any other communication device or a user-interface device. An access terminal 100 may be stationary or portable, and may be used for connection to an area network outside of RAN 110, for instance a network utilizing Code Division Multiple Access (CDMA) communication protocols (a CDMA network is not illustrated in FIG. 1).

In one aspect of the disclosure, a packet data gateway (PDG) 130 may be any communication device or a gateway device. In another aspect, a packet data gateway may be a gateway device for receiving and/or sending data packets.

In one aspect of the disclosure, a VoIP communication channel 120 may support voice, push-to-talk, video telephony, media, and/or data communication.

In one aspect of the subject technology, access terminal 100 may be transported by a user from an area outside, to an area inside, of the coverage provided by RAN 110 (the coverage area is conceptually illustrated by the dashed lines of RAN 110). RAN 110 sits at the front of packet data gateway (PDG) 130, and provides communication access between access terminal 100 and PDG 130. Access terminal 100 is configured to monitor its immediate environment for the existence of a radio area network, such as RAN 110. Once inside the coverage area of RAN 110, access terminal 100 automatically sends a request for a PPP link-up to PDG 130, including information on the QoS levels required by access terminal 100. QoS levels may be determined by the type of hardware comprising access terminal 100, or the QoS may be determined by the type or types of applications employed by access terminal 100, as one of ordinary skill in the art would understand.

In many instances, PDG 130 will be able to meet the QoS requirements of access terminal 100, in which case, a VoIP communication channel 120 is established from access terminal 100 to PDG 130. Packets of information (whether voice or data) may then be transmitted and received from/to access terminal 100 and to/from IP Packet Data Network 140, and/or on to a PSTN circuit-switched network such as PSTN 150. In another aspect of the subject technology, packets of information may be transmitted from/to access terminal 100 to/from a receiver (not shown) connected to the IP Packet Data Network 140. One of ordinary skill in the art would comprehend that such a receiver may be any one of a multiple number of devices (such as a telephone, cell phone, laptop or desktop computer, a printer, or other user device), so long as the receiver could be connected to access terminal 100, e.g., via VoIP communication channel 120 through PDG 130 and IP Packet Data Network 140.

In one aspect of the subject technology, at a time that access terminal 100 requests a PPP link-up, PDG 130 may be servicing other access terminals (not shown). For example, at the time of the request for a PPP link-up from access terminal 100, PDG 130 may be unable to fulfill the request due to demands from other access terminals, or for a variety of other reasons (for example, temporary network problems, restricted bandwidth, or an inability to meet the QoS requirements sent by access terminal 100). According to one aspect of the subject technology, if PDG 130 is unable to fulfill the request for a PPP link-up with access terminal 100 for any reason, access terminal 100 begins a countdown of a predetermined amount (e.g., a 1 minute countdown), using for instance, a digital timer.

When the countdown expires, access terminal 100 then begins an automated process of once again requesting a PPP link-up that includes the requested QoS requirements. If access terminal 100 is once again unable to establish a PPP link-up, then access terminal 100 begins a countdown of another predetermined amount (e.g., a 2 minute countdown).

In one aspect of the subject technology, the process of requesting a PPP link-up and being denied a link-up, concludes in each instance with the time period of the countdown timer being increased (e.g., doubled for each denial). Such a process may be reiterated until, for example, a countdown of 32 minutes is reached.

A starting countdown of 1 minute, coupled with a doubling of the countdown for every subsequent denial until 32 minutes is reached, is merely a non-exclusive example. In one aspect of the subject technology, the countdown (or “waiting period”) may be a constant time period. For example, access terminal 100 may re-attempt to acquire a PPP link-up every minute, or every 30 seconds. In another aspect of the subject technology, the waiting period may become progressively larger (e.g., doubling, tripling, growing exponentially, or by adding a set amount of time, for example, an additional minute every time that PDG 130 is unable to provide a VoIP communication channel 120 to access terminal 100, for whatever reason).

In yet another aspect of the subject technology, the waiting period may at first grow larger with each subsequent denial of a PPP link-up (e.g., doubling, tripling, growing exponentially, or otherwise) for a set number of denials, for example, five denials, and then the waiting period may settle on a constant time period that continues until access terminal 100 is provided with a VoIP communication channel 120, or until access terminal 100 is no longer within the coverage area of RAN 110. In yet another aspect of the subject technology, the waiting period may be configured to start at a low interval, for example, 10 seconds, or at a large interval, for example, 2 minutes.

According to one aspect of the subject technology, the waiting period or the time period is configurable (e.g., changeable, selectable, or programmable by a user or machine), and it may be configured to one or more predetermined values.

An advantage of the subject technology is, for example, that an access terminal 100 will automatically keep trying to acquire a VoIP communication channel 120 from PDG 130 until access terminal 100 either succeeds or is no longer in the coverage area provided by RAN 110. In one aspect of the subject technology, the automatic attempt(s) to acquire the resources needed for VoIP communication channel 120 are made with low enough frequency such that the attempts do not load the network as much as would a constant (or nearly constant) re-attempt to acquire a PPP link-up.

During the time that the request from access terminal 100 to PDG 130 for a PPP link-up is not satisfied, the access terminal is non-VoIP capable but, nonetheless, in another aspect of the subject technology, may continue to provide information (whether voice or data) service on another network (including either of a circuit-switched network or a packet-switched network).

In one aspect of the subject technology, access terminal 100 differentiates between different networks, and based on coverage areas and network capabilities, automatically connects to IP Packet Data Network 140 through PDG 130 via VoIP communication channel 120 over RAN 110 without any manual intervention from the user.

An arrangement as that described above in relation to FIG. 1 provides a high level of integration with various chipsets for VoIP services, and is expected to result in both higher consumer satisfaction and easier implementation by original equipment manufacturers.

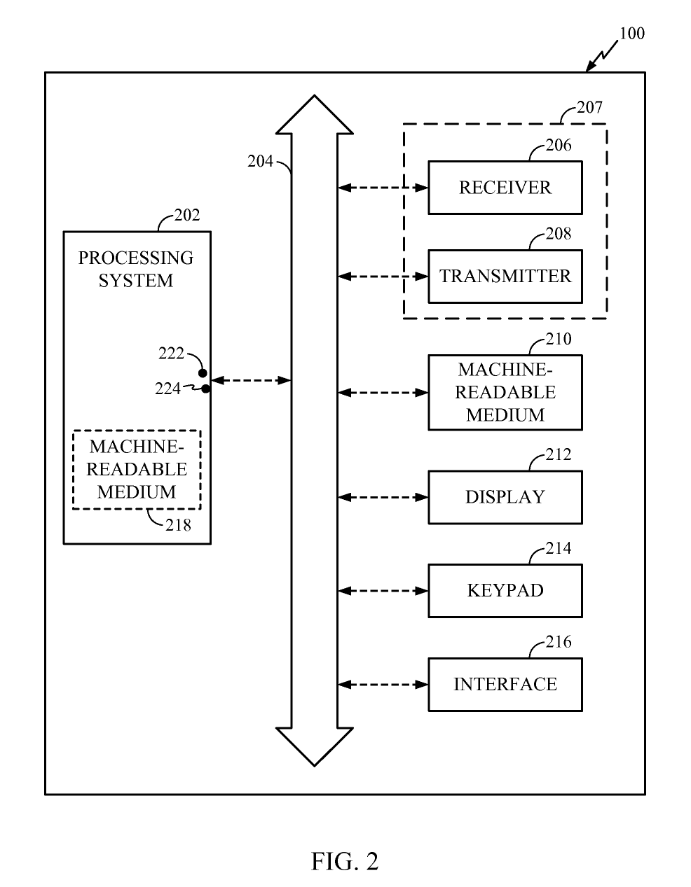

FIG. 2 is a conceptual block diagram illustrating an example of an access terminal 100. Access terminal 100 may include a transceiver 207. Transceiver 207 may comprise a receiver 206 and a transmitter 208, and is configured to receive/transmit a signal using an antenna (not shown). Transceiver 207 is configured to be communicatively coupled to a processing system 202 via bus 204. Access terminal 100 may further include a machine-readable medium 210/218 that is/are configured to be communicatively coupled to processing system 202.

Access terminal 100 may further include a display 212, a keypad 214, and an interface 216, which may include one or more of a touch screen and/or optical device (e.g., a camera). Of course, one skilled in the art would realize that all components shown in FIG. 2 may be coupled to machine-readable medium 210/218 and/or processing system 202 for implementation of various, respective functions. Access terminal 100 is not limited to any particular configuration. Various combinations of components, including additional components not illustrated in FIG. 2, may be included as part of access terminal 100. Processing system 202 may include an input port 222 and an output port 224. Either or both of input port 222 and output port 224 may be a USB or another type of hardwire connection, or may be a wireless connection, for example, infrared ports, for providing inter-connectivity between access terminal 100 and other devices.

Processing system 202 may include one or more of a general-purpose processor or a specific-purpose processor for executing instructions and may further include machine-readable medium 218 (e.g., volatile or non-volatile memory) for storing data and instructions for software programs. A processor may include one or more processors. Processing system 202 may be implemented using software, hardware, or a combination of both. By way of example, a processor as part of processing system 202 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information. The term “software” is intended to be construed broadly to include instructions, data, or any combination thereof, whether referred to as software, firmware, middleware, microcode, hardware description language, or otherwise. Instructions may include code (e.g., source code format, binary code format, executable code format, or any other suitable format of code).

One of ordinary skill in the art would understand that machine-readable medium (e.g., 218) may include any machine-readable media or storage integrated into a processing system, such as might be the case with an ASIC. Machine-readable medium (e.g., 210) may include any machine-readable media or storage external to a processing system, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device. Machine-readable medium 210/218 may include one or more media. According to one aspect of the disclosure, a machine-readable medium is a computer-readable medium encoded or stored with instructions and is a computing element, which defines structural and functional interrelationships between the instructions and the rest of the system, which permit the instructions' functionality to be realized. Instructions may be executable, for example, by an access terminal, or by a processor of an access terminal. Instructions can be, for example, a computer program including code for execution by a processor.

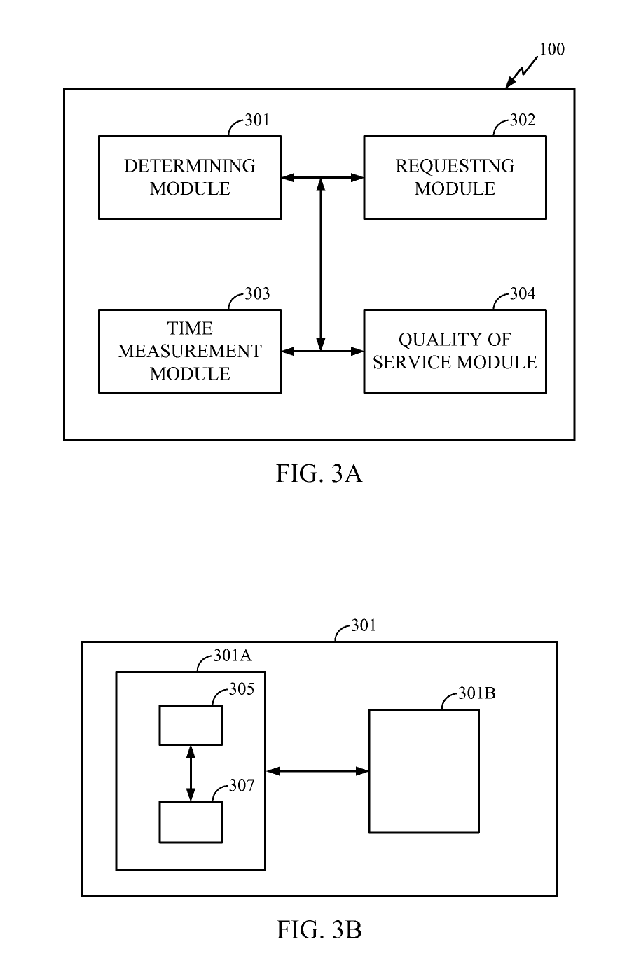

FIG. 3A is a conceptual block diagram illustrating an example of an access terminal's functional components according to one configuration of the subject technology. An access terminal 100 may include various modules comprised of hardware and/or software for providing certain functionality.

In accordance with one configuration, access terminal 100 may comprise a determining module 301, a requesting module 302, a time measurement module 303, and a quality of service module 304. As noted above in relation to FIG. 2, access terminal 100 may comprise one or more of a general-purpose processor or a specific-purpose processor for executing instructions, and may further include volatile or non-volatile memory for storing data and instructions for software programs.

Now referring to FIG. 3B, in accordance with one configuration of the subject technology, determining module 301 of an access terminal 100 may comprise two sub-modules: module 301A and module 301B. In accordance with one aspect of the subject technology, module 301A of determining module 301 is configured to provide a determination of whether an access terminal 100 is within a VoIP-available communication environment, such as that provided by RAN 110 (shown in FIG. 1). Such a determination may be carried out by an access terminal 100 by utilizing, for example, a monitoring module 305 and a look-up table or a threshold comparator circuit 307. Monitoring module 305 may monitor for a signal from PDG 130 in RAN 110 (as shown in FIG. 1). In one aspect, monitoring module 305 is coupled to receiver 206, and the monitoring may be performed constantly. Look-up table or threshold comparator circuit 307 may determine if the signal from PDG 130 meets a threshold power level to sustain communication between access terminal 100 and PDG 130.

In accordance with one aspect of the subject technology, module 301B of determining module 301 is configured to make a channel determination, for example, a determination of which specific channel from among a plurality of VoIP communication channels to use, or whether the channel may be configured to support High Speed Packet Access (HSPA) or Evolution Data Optimized Rev A (DO Rev A) protocols, or whether the VoIP communication channel will support any of voice, push-to-talk, video telephony, media and/or data transmission.

Referring back to FIG. 3A, in accordance with one aspect of the subject technology, requesting module 302 includes the functionality of requesting, on entry into a VoIP-available communication environment, first and subsequent VoIP client requests asking for a point-to-point protocol (PPP) link-up and comprising an access terminal's Quality of Service (QoS) requirements. If the PPP link-up and/or QoS requirements can be provided, as reported to access terminal 100 by the VoIP network, then access terminal 100 initiates communication between the access terminal and the VoIP network over a VoIP communication channel. If the PPP and/or QoS requirements cannot be provided, then access terminal 100 proceeds with providing the functionality of module 303.

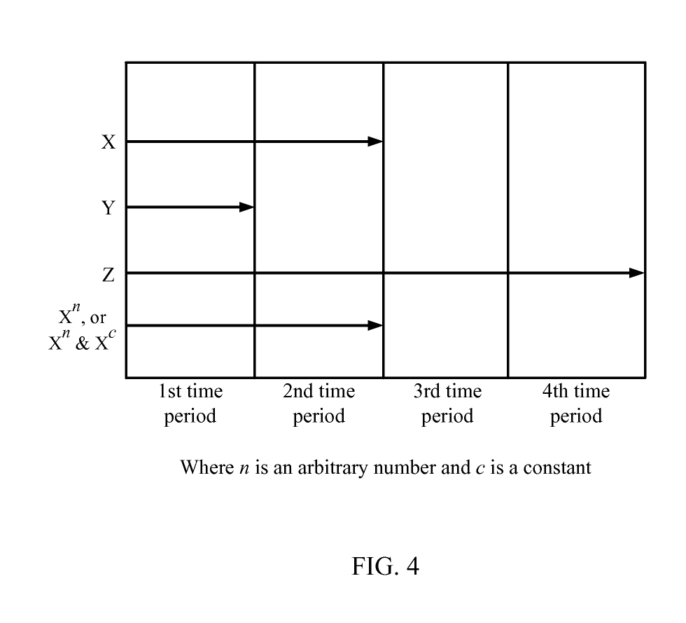

In accordance with one aspect of the subject technology, a time measurement module 303 in FIG. 3A measures the time between each request for a PPP link-up. Time measurement module 303 is configured to provide a waiting period for access terminal 100 prior to re-submitting additional requests for a VoIP communication channel after a first denial and subsequent denials of a PPP link-up. In an aspect of the subject technology, the waiting period may be constant, or may change over time, becoming progressively shorter or longer. According to various aspects of the subject technology, the waiting period may be as that described above in relation to FIG. 1, or as described below in relation to FIG. 4.

In accordance with one aspect of the subject technology, a quality of service module 304 provides the functionality of ensuring that access terminal 100's quality of service (QoS) requirements are met and remain so throughout the time that a VoIP communication channel is maintained between access terminal 100 and the VoIP network. Module 304 may include imposing Real-time Transport Protocol (RTP) requirements that define how streaming audio and/or video may be sent over an Internet Protocol, for example, VoIP communication channel 120. The quality of service module 304 may include a Real-time Transport Control Protocol (RTCP) that monitors QoS requirements over time to ensure that they are being met in an on-going PPP link-up.

In accordance with one configuration, a processing system 202 of FIG. 2 may comprise modules 301, 302, 303, and 304 of FIG. 3A. In accordance with another configuration, a processing system 202 of FIG. 2 may comprise some of the functionality of modules 301, 302, 303, and 304, and other one or more components shown in FIG. 2 may comprise other portions of the functionality of modules 301, 302, 303, and 304.

FIG. 4 is a conceptual graph illustrating examples of waiting periods that may be used by an access terminal in various aspects of the subject technology. As described above, in accordance with one aspect of the subject technology, an access terminal 100 is configured to employ a “back-off, retry” behavior when confronted with a denial of a PPP link-up (for any reason). As part of the “back-off” portion, access terminal 100 begins a countdown when a PPP link-up is not provided after a request for a VoIP communication channel has been made. FIG. 4 illustrates examples of conceptual time periods that access terminal 100 may be configured to wait for prior to re-submitting a request for a VoIP communication channel from PDG 130. As shown in FIG. 4, a waiting period may be, for example, any time period X, Y, or Z, where Y is less than X, and Z is greater than both X and Y.

In another example, a waiting period may be any of (i) Xⁿ or (ii) Xⁿ in combination with X^{c}, where the exponent n is any arbitrary number, and exponent c is a constant number. For instance, in one aspect of the subject technology, the waiting period may be Xⁿ, where X is 60 seconds and n is a progressively larger exponent (whether as a whole number or as a fractional exponent), such that each subsequent waiting period increases exponentially, for example, from an original waiting period of 60 seconds, to 120 seconds, to 180 seconds, to 240 seconds, etc. In another aspect of the subject technology, the Xⁿ and X^{c} combination may provide that an initial waiting period comprises a first waiting period of 60 seconds, followed by a certain number of progressively larger waiting periods (such as 120, 240, and 480 seconds) before the waiting period ultimately settles on a constant waiting period, for example, 32 minutes. It should be noted that FIG. 4 simply presents some examples, and the subject technology is not limited to these examples.

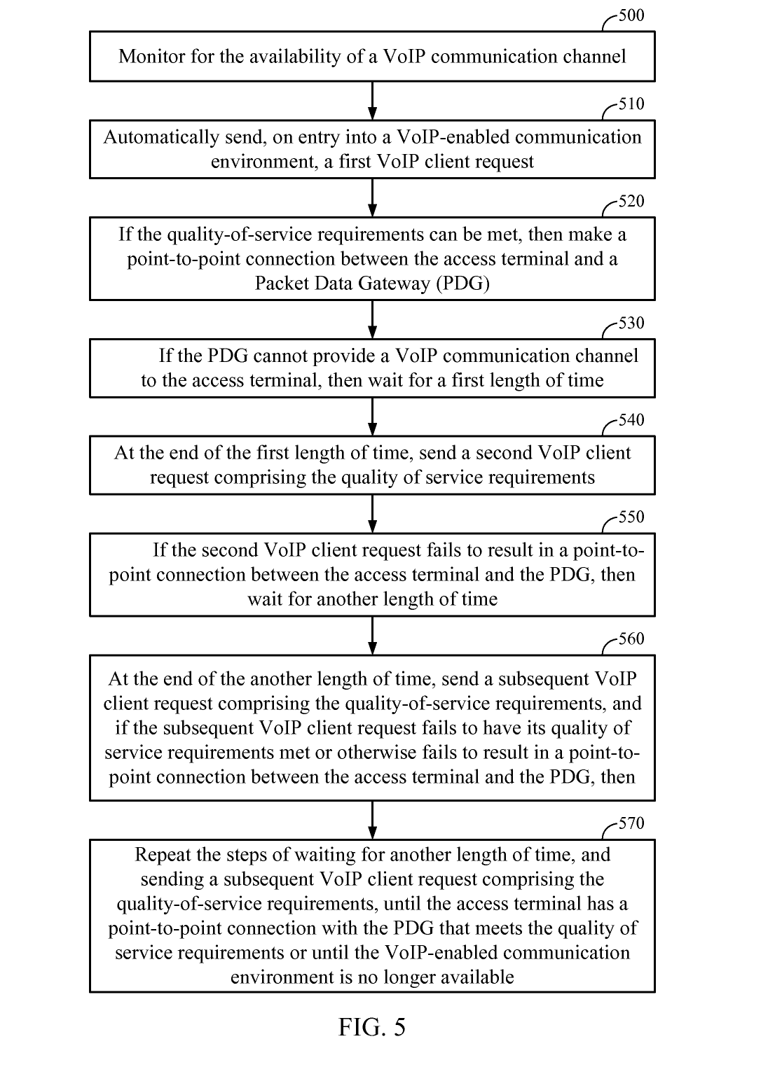

FIG. 5 is a conceptual flowchart illustrating an example of an operation of an access terminal in accordance with an aspect of the subject technology. As shown in FIG. 5, at block 500, an access terminal 100 may monitor its local environment for availability of a VoIP communication channel through a Radio Access Network (RAN) 110 of FIG. 1, and automatically send (as shown in block 510), on entry into a VoIP-available communication environment (e.g., a RAN 110), a first VoIP client request for one or more VoIP network connection resources.

In one aspect of the disclosure, a request may comprise an access terminal 100's quality-of-service requirements. In one aspect of the disclosure, one or more VoIP network connection resources may include a point-to-point communication connection meeting one or more quality-of-service requirements of an access terminal. In another aspect, one or more VoIP network connection resources may include a VoIP communication channel that meets one or more quality-of-service requirements of an access terminal. In yet another aspect, one or more VoIP network connection resources may include a reply or a confirmation that one or more quality-of-service requirements of an access terminal can be met. In yet another aspect, one or more VoIP network connection resources may include a reply or a confirmation that one or more quality-of-service requirements of an access terminal can be met, and have been allocated or reserved in a VoIP network.

As shown in block 520, if the quality-of-service requirements can be met, access terminal 100 makes a point-to-point communication connection with a packet data gateway (PDG) 130 through RAN 110. As shown in block 530, if PDG 130 cannot provide a VoIP communication channel to access terminal 100 (because the quality-of-service requirements cannot be met or otherwise), then access terminal 100 waits for a first length of time. As shown in block 540, at the end of the first length of time, access terminal 100 sends a second VoIP client request comprising the quality-of-service requirements.

As shown in block 550, if the second VoIP client request fails to result in a point-to-point communication connection between access terminal 100 and PDG 130 (because the quality-of-service requirements cannot be met or otherwise), then access terminal 100 waits for another length of time. The another length of time may be selected from the group consisting of the first length of time, a shorter length of time, a longer length of time, and a progressively longer length of time.

As shown in block 560, access terminal 100 may send, at the end of the another length of time, a subsequent VoIP client request comprising the quality-of-service requirements, and if the subsequent VoIP client request fails to have its quality-of-service requirements met or otherwise fails to result in a point-to-point communication connection between access terminal 100 and PDG 130, then, as shown in block 570, the steps of waiting for yet another length of time and sending a subsequent VoIP client request comprising the quality-of-service requirement, are repeated until access terminal 100 has a point-to-point communication connection with PDG 130 that meets the quality-of-service requirements or until the VoIP-enabled communication environment is no longer available.

In one aspect of the disclosure, a processing system (e.g., processing system 202 in FIG. 2) may perform the process described in FIG. 5. A processing system may alert a user to at least one of the following occurrences: (i) an access terminal entering a VoIP-enabled communication environment, (ii) the access terminal leaving a VoIP-enabled communication environment, (iii) the access terminal making a point-to-point communication connection with a packet data gateway, and (iv) the access terminal losing a point-to-point communication connection with a packet data gateway. The processing system may alert the user using one or more of audible, visual, and tactile components.

In one aspect of the disclosure, if an access terminal (e.g., access terminal 100 in FIG. 1) enters a VoIP-enabled communication environment (e.g., RAN 110), a processing system may allow a user to stop the request for one or more VoIP network connection resources.

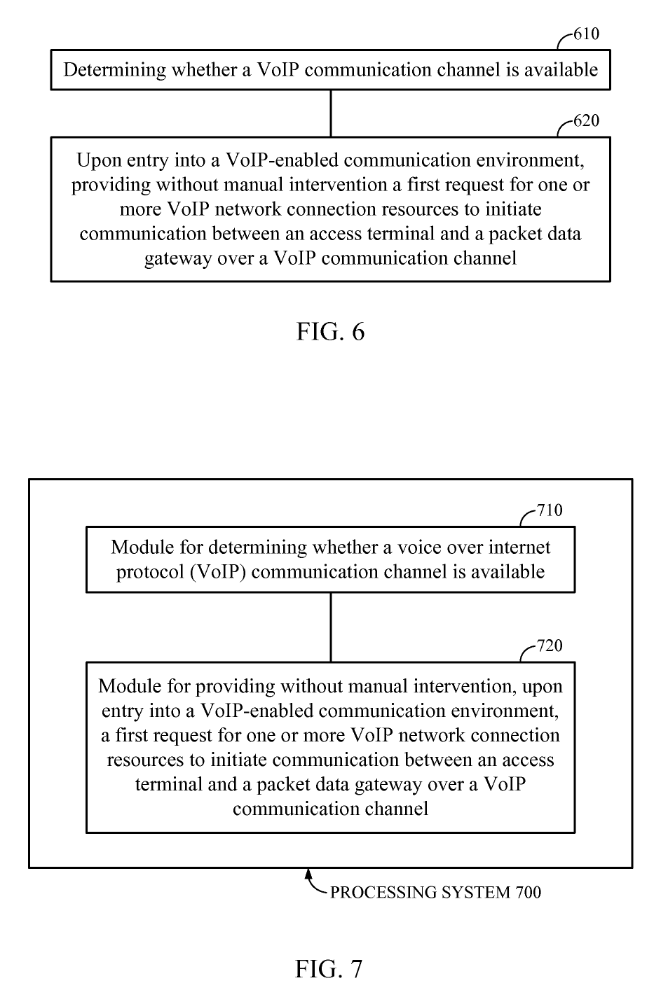

FIG. 6 is a conceptual flowchart illustrating another example of an operation of an access terminal in accordance with an aspect of the subject technology. An operation of an access terminal includes procedure 610, which determines whether a VoIP communication channel is available. The operation also includes procedure 620, which, upon entry into a VoIP-enabled communication environment, provides without manual intervention a first request for one or more VoIP network connection resources to initiate communication between an access terminal and a packet data gateway over a VoIP communication channel.

FIG. 7 is a conceptual block diagram illustrating an example of a processing system in accordance with an aspect of the subject technology. A processing system 700 includes module 710 for determining whether a voice over internet protocol (VoIP) communication channel is available. The processing system 700 also includes module 720 for providing without manual intervention, upon entry into a VoIP-enabled communication environment, a first request for one or more VoIP network connection resources to initiate communication between an access terminal and a packet data gateway over a VoIP communication channel.

In accordance with one aspect of the subject technology, a backoff algorithm may perform VoIP service startup during network failure on Evolution Data Optimized Revision A (EV-DO or DO Rev A) or High Speed Packet Access (HSPA) networks.

According to one aspect of the subject technology, VoIP service capability is dependent on having a Point-to-Point Protocol (PPP) link up and capability of a Radio Area Network (RAN) to authorize Quality of Service (QoS). For VoIP over DO Rev A or HSPA, it is quite possible that due to poor coverage or temporary congestion in the network, an access terminal 100's request to open the PPP link or request for QoS can not be honored. At the startup time, access terminal 100 may send a VoIP client request for the PPP link to be open and VoIP media Real-time Transport Protocol (RTP) QoS to be configured in the network for later request for the actual QoS. Once these steps are performed and a positive confirmation is received, access terminal 100 is capable of providing the VoIP service. However, when access terminal 100 requests for a PPP link to be up or QoS to be configured in the network, access terminal 100 could be in DO Rev 0 coverage (non-QoS) or there may be temporary load condition in the network due to which network will not grant the request.

According to one aspect of the subject technology, a backoff retry behavior is implemented to request necessary resources during failure. In such a scheme, after a failure upon power-up, access terminal 100 may start, for example, a 1 minute timer. If the timer expires, it can request again a PPP setup or QoS (as per the prior failure). If it fails again, it can start the timer, for instance, for 2 minutes. This process continues until the timer reaches, for example, 32 minutes. In this example, at every failure, the next timer value is twice the previous timer value until it settles at 32 minutes. The time period is configurable (e.g., to start at lower interval). An advantage of the subject technology is that an access terminal 100 can automatically keep trying to get resources from the network until it succeeds and with low enough frequency such that it does not load the network too much. During the time this request is not satisfied, an access terminal 100 is non-VoIP capable and can continue to provide voice service on other networks such as a circuit-switched network. If an operator provides a VoIP service that is a differentiating service, an access terminal 100 is smart enough to get that service based on coverage and network capability without any manual intervention. This provides much higher level of integration in a chipset for VoIP service resulting in higher consumer satisfaction and less work required by the original equipment manufacturer (OEMs) to implement such a mechanism.

According to one approach, a VoIP application such as a Binary Run-time Environment for Wireless (BREW) application, requires a user to select VoIP via a menu and requires the user to request it to be activated. If VoIP is failed, it again requires manual intervention (e.g., an input from a user). Even if an access terminal is within a network coverage area where it might have VoIP capability (QoS/PPP, etc.), the access terminal will not request these resources automatically.

In accordance with one aspect, the subject technology allows an access terminal to automatically request for required network resources without manual intervention. This results in acquiring differentiating VoIP service for the access terminal without user manual intervention.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. An access terminal, comprising:
a processing system configured to determine whether a voice over internet protocol (VoIP) communication channel is available,
the processing system configured, upon entry into a VoIP-enabled communication environment, to provide without manual intervention a first request for one or more VoIP network connection resources to initiate communication between the access terminal and a packet data gateway over a VoIP communication channel.

2. The access terminal of claim 1, wherein if one or more VoIP network connection resources are not received by the access terminal, the processing system is configured to repeatedly perform the following actions, without manual intervention, until one or more VoIP network connection resources are received, or until the VoIP-enabled communication environment becomes unavailable: waiting and providing a subsequent request for one or more VoIP network connection resources.

3. The access terminal of claim 2, wherein each of the first request and a subsequent request comprises one or more quality-of-service requirements for the access terminal.

4. The access terminal of claim 1, wherein the one or more VoIP network connection resources comprise a point-to-point communication connection meeting one or more quality-of-service requirements of the access terminal.

5. The access terminal of claim 2, wherein the waiting and providing are repeated at least twice, wherein the waiting comprises: waiting for a first time period after the first request for one or more VoIP network connection resources, and waiting for a second time period after a subsequent request for one or more VoIP network connection resources, and wherein the first time period is different from the second time period.

6. The access terminal of claim 5, wherein each of the first time period and the second time period is configurable.

7. The access terminal of claim 2, wherein if the waiting is repeated, a length of waiting time is increased for each waiting instance.

8. The access terminal of claim 1, wherein the processing system is configured to monitor, without manual intervention, for an availability of a VoIP communication channel, and the processing system is configured to determine, without manual intervention, whether a VoIP communication channel is available.

9. The access terminal of claim 1, wherein the VoIP communication channel is at least one of a High Speed Packet Access communication channel, an Evolution Data Optimized communication channel, and a Radio Access Network communication channel.

10. The access terminal of claim 1, wherein the processing system is configured to continue voice service on a network while providing without manual intervention the first request for one or more VoIP network connection resources, and wherein the network is different from the VoIP-enabled communication environment.

11. The access terminal of claim 1, wherein the processing system is configured to alert a user to at least one of the following occurrences: (i) the access terminal entering a VoIP-enabled communication environment, (ii) the access terminal leaving a VoIP-enabled communication environment, (iii) the access terminal making a point-to-point communication connection with a packet data gateway, and (iv) the access terminal losing a point-to-point communication connection with a packet data gateway.

12. The access terminal of claim 1, wherein the processing system is configured, if the access terminal enters a VoIP-enabled communication environment, to allow a user to stop the first request for one or more VoIP network connection resources.

13. The access terminal of claim 1, further comprising: a transceiver, a machine-readable medium, a display, a keypad, an interface, an input port, and an output port.

14. A method for initiating a voice over internet protocol (VoIP) service, the method comprising:
determining whether a VoIP communication channel is available; and
upon entry into a VoIP-enabled communication environment, providing without manual intervention a first request for one or more VoIP network connection resources to initiate communication between an access terminal and a packet data gateway over a VoIP communication channel.

15. The method of claim 14, further comprising:
if one or more VoIP network connection resources are not received by the access terminal, repeatedly performing the following actions, without manual intervention, until one or more VoIP network connection resources are received, or until the VoIP-enabled communication environment becomes unavailable: waiting and providing a subsequent request for one or more VoIP network connection resources.

16. The method of claim 15, wherein each of the first request and a subsequent request comprises one or more quality-of-service requirements for the access terminal.

17. The method of claim 14, wherein the one or more VoIP network connection resources comprise a point-to-point communication connection meeting one or more quality-of-service requirements of the access terminal.

18. The method of claim 15, wherein the waiting and providing are repeated at least twice, wherein the waiting comprises: waiting for a first time period after the first request for one or more VoIP network connection resources, and waiting for a second time period after a subsequent request for one or more VoIP network connection resources, and wherein the first time period is different from the second time period.

19. The method of claim 18, wherein each of the first time period and the second time period is configurable.

20. The method of claim 15, wherein if the waiting is repeated, a length of waiting time is increased for each waiting instance.

21. The method of claim 14, wherein the determining comprises:
monitoring, without manual intervention, for an availability of a VoIP communication channel; and
determining, without manual intervention, whether a VoIP communication channel is available.

22. The method of claim 14, wherein the providing comprises continuing voice service on a network while providing without manual intervention the first request for one or more VoIP network connection resources, and wherein the network is different from the VoIP-enabled communication environment.

23. A processing system, comprising:
a determining module configured to determine whether a voice over internet protocol (VoIP) communication channel is available; and
a requesting module configured, upon entry into a VoIP-enabled communication environment, to provide without manual intervention a first request for one or more VoIP network connection resources to initiate communication between an access terminal and a packet data gateway over a VoIP communication channel.

24. The processing system of claim 23, wherein if one or more VoIP network connection resources are not received by the access terminal, the requesting module is configured to repeatedly perform the following actions, without manual intervention, until one or more VoIP network connection resources are received, or until the VoIP-enabled communication environment becomes unavailable: waiting and providing a subsequent request for one or more VoIP network connection resources.

25. The processing system of claim 24, wherein each of the first request and a subsequent request comprises one or more quality-of-service requirements for the access terminal.

26. The processing system of claim 23, wherein the one or more VoIP network connection resources comprise a point-to-point communication connection meeting one or more quality-of-service requirements of the access terminal.

27. The processing system of claim 24, wherein the waiting and providing are repeated at least twice, wherein the waiting comprises: waiting for a first time period after the first request for one or more VoIP network connection resources, and waiting for a second time period after a subsequent request for one or more VoIP network connection resources, and wherein the first time period is different from the second time period.

28. The processing system of claim 27, wherein each of the first time period and the second time period is configurable.

29. The processing system of claim 24, wherein if the waiting is repeated, a length of waiting time is increased for each waiting instance.

30. The processing system of claim 23, wherein the determining module is configured to monitor, without manual intervention, for an availability of a VoIP communication channel, and the determining module is configured to determine, without manual intervention, whether a VoIP communication channel is available.

31. The processing system of claim 23, wherein the requesting module comprises continuing voice service on a network while providing without manual intervention the first request for one or more VoIP network connection resources, and wherein the network is different from the VoIP-enabled communication environment.

32. A processing system, comprising:
means for determining whether a voice over internet protocol (VoIP) communication channel is available; and
means for providing without manual intervention, upon entry into a VoIP-enabled communication environment, a first request for one or more VoIP network connection resources to initiate communication between an access terminal and a packet data gateway over a VoIP communication channel.

33. The processing system of claim 32, further comprising:
means for, if one or more VoIP network connection resources are not received by the access terminal, repeatedly performing the following actions, without manual intervention, until one or more VoIP network connection resources are received, or until the VoIP-enabled communication environment becomes unavailable: waiting and providing a subsequent request for one or more VoIP network connection resources.

34. The processing system of claim 33, wherein each of the first request and a subsequent request comprises one or more quality-of-service requirements for the access terminal.

35. The processing system of claim 32, wherein the one or more VoIP network connection resources comprise a point-to-point communication connection meeting one or more quality-of-service requirements of the access terminal.

36. The processing system of claim 33, wherein the waiting and providing are repeated at least twice, wherein the waiting comprises: waiting for a first time period after the first request for one or more VoIP network connection resources, and waiting for a second time period after a subsequent request for one or more VoIP network connection resources, and wherein the first time period is different from the second time period.

37. The processing system of claim 36, wherein each of the first time period and the second time period is configurable.

38. The processing system of claim 33, wherein if the waiting is repeated, a length of waiting time is increased for each waiting instance.

39. The processing system of claim 32, wherein the means for determining comprises:
means for monitoring, without manual intervention, for an availability of a VoIP communication channel; and
means for determining, without manual intervention, whether a VoIP communication channel is available.

40. The processing system of claim 32, wherein the means for providing comprises means for continuing voice service on a network while providing without manual intervention the first request for one or more VoIP network connection resources, and wherein the network is different from the VoIP-enabled communication environment.

41. A machine-readable medium encoded with instructions for initiating or performing a voice over internet protocol (VoIP) service, the instructions comprising code for:
determining whether a VoIP communication channel is available; and
upon entry into a VoIP-enabled communication environment, providing without manual intervention a first request for one or more VoIP network connection resources to initiate communication between an access terminal and a packet data gateway over a VoIP communication channel.

42. The machine-readable medium of claim 41, wherein the instructions further comprise code for:
if one or more VoIP network connection resources are not received by the access terminal, repeatedly performing the following actions, without manual intervention, until one or more VoIP network connection resources are received, or until the VoIP-enabled communication environment becomes unavailable: waiting and providing a subsequent request for one or more VoIP network connection resources.

43. The machine-readable medium of claim 42, wherein each of the first request and a subsequent request comprises one or more quality-of-service requirements for the access terminal.

44. The machine-readable medium of claim 41, wherein the one or more VoIP network connection resources comprise a point-to-point communication connection meeting one or more quality-of-service requirements of the access terminal.

45. The machine-readable medium of claim 42, wherein the waiting and providing are repeated at least twice, wherein the waiting comprises: waiting for a first time period after the first request for one or more VoIP network connection resources, and waiting for a second time period after a subsequent request for one or more VoIP network connection resources, and wherein the first time period is different from the second time period.

46. The machine-readable medium of claim 45, wherein each of the first time period and the second time period is configurable.

47. The machine-readable medium of claim 42, wherein if the waiting is repeated, a length of waiting time is increased for each waiting instance.

48. The machine-readable medium of claim 41, wherein the determining comprises:
monitoring, without manual intervention, for an availability of a VoIP communication channel; and
determining, without manual intervention, whether a VoIP communication channel is available.

49. The machine-readable medium of claim 41, wherein the providing comprises continuing voice service on a network while providing without manual intervention the first request for one or more VoIP network connection resources, and wherein the network is different from the VoIP-enabled communication environment.
